(19) United States
(12) Patent Application Publication
(10) Pub. No.: US 2010/0182103 A1
(43) Pub. Date: Jul. 22, 2010

(54) INTERCONNECTION APPARATUS AND METHOD FOR LOW CROSS-TALK CHIP MOUNTING FOR AUTOMOTIVE RADARS

(75) Inventors: Alexandros Margomenos, Pasadena, CA (US); Amin Rida, Atlanta, GA (US)

Correspondence Address: SNELL & WILMER LLP (OC), 600 ANTON BOULEVARD, SUITE 1400, COSTA MESA, CA, 92626, US

(73) Assignee: TOYOTA MOTOR ENGINEERING & MANUFACTURING NORTH AMERICA, INC., Erlanger, KY (US)

(21) Appl. No.: 12/697,119

(22) Filed: Jan. 29, 2010

Related U.S. Application Data
(63) Continuation-in-part of application No. 12/355,526, filed on Jan. 16, 2009.

(51) Int. Cl. H01P 3/08

(52) U.S. Cl. 333/204

(57) ABSTRACT

An apparatus for reducing crosstalk including a substrate having a bottom surface and a top surface defining a horizontal plane, a ground plane coupled to the bottom surface of the substrate, first and second microstrip lines formed on the top surface of the substrate, the first and second microstrip lines formed on the top surface of the substrate and spaced apart from one another, and a first plurality of vias traveling through the substrate from the top surface of the substrate to the ground plane and positioned between the first and second microstrip lines for reducing crosstalk between the first and second microstrip lines.

### CLAIM OF PRIORITY UNDER 35 U.S.C. §120

The present Application for Patent claims priority from and is a continuation-in-part application of co-pending U.S. patent application Ser. No. 12/355,526, entitled “Method for improving performance of Coplanar Waveguide Bends at mm-wave frequencies,” filed Jan. 16, 2009, and assigned to the assignee hereof and hereby expressly incorporated by reference herein.

### BACKGROUND

1. Field

The invention relates to apparatus and methods for mounting and interconnecting a Radio Frequency Integrated Circuit (RFIC) for automotive radar applications. More particularly, the invention relates to an interconnection apparatus and method for low cross-talk chip mounting for automotive radars.

2. Background

Many automotive designers and manufacturers are seeking to produce high-density microwave modules that achieve good isolation between circuit elements. In particular, transceiver applications (e.g., radar and communication RF front-ends) need to have good isolation to ensure receiver sensitivity and prevent leakage between channels.

Multilayer architectures incorporating complex circuits on a common substrate material pose some challenging isolation problems. For example, when circuits are printed on a common substrate, surface waves excited by planar discontinuities or leaky modes tend to induce parasitic currents on neighboring interconnects and circuits leading to unwanted interference. This parasitic coupling becomes increasingly more problematic as circuits are printed on multilayered structures for higher density and smaller size. In such multilayered structures, proximity effects are dependent on the interconnect geometry. The layout design and relative placement of lines, vias and vertical transitions should be carefully considered in order to reduce any unwanted interference.

Isolation becomes more important and more problematic at the connections to the RFIC chip since most of the signal transmission lines converge on a very small area (typically around 3×3 mm²) adjacent to the RFIC chip and are interconnected to the RFIC chip. Due to their close proximity, these signal transmission lines tend to interfere with one another causing deleterious effects on the radar performance. Furthermore, RFIC chips (e.g., SiGe BiCMOS and RF CMOS chips) tend to integrate multiple signal transmission lines (e.g., 4, 8 or 16) on a single chip, further emphasizing the need to have good isolation between the signal transmission lines.

FIG. 1 is a schematic view of a prior art 3D integrated radar RF front-end system 100 having antennas 105 that are combined together using transmission lines 110 on a liquid crystal polymer (LCP) substrate 120. The antennas 105 are printed on the front-side and the transmission lines 110 are printed on the backside. The transmission lines 110 are connected to an RFIC chip 115. The transmission lines 110 provide good performance in terms of loss and low crosstalk (i.e., every channel is completely isolated from the others and extremely low levels of crosstalk are achievable). Instead of using machined metallic waveguides, the transmission lines 110 are planar lines that are printed on the LCP substrate 120. The planar lines are microstrip lines at the topside and coplanar waveguides (CPW) at the backside.

The LCP substrate 120 may be a single 100 um thick LCP layer mounted on a printed circuit board (PCB) that contains all the digital signal processing and control signals. The LCP substrate 120 has a planar phased array beam-steering antenna array 105 printed on one side. The signals from each antenna 105 are transitioned to the backside with a 3D vertical transition 125. In the backside, the signals converge to the RFIC chip 115.

Although the foregoing prior art 3D integrated radar RF front-end system 100 is helpful in reducing the crosstalk between these types of transmission lines 110, additional improvements can be made to reduce the crosstalk between these types of transmission lines 110 as these lines converge towards the RFIC chip 115 on the backside. Also, additional improvements can be made to reduce the crosstalk between CPW interconnections or transmission lines. Therefore, a need exists in the art for an interconnection apparatus and method for low cross-talk chip mounting for automotive radars.

### SUMMARY

An apparatus for reducing crosstalk including a substrate having a bottom surface and a top surface defining a horizontal plane, a ground plane coupled to the bottom surface of the substrate, first and second microstrip lines formed on the top surface of the substrate, the first and second microstrip lines formed on the top surface of the substrate and spaced apart from one another, and a first plurality of vias traveling through the substrate from the top surface of the substrate to the ground plane and positioned between the first and second microstrip lines for reducing crosstalk between the first and second microstrip lines.

In one embodiment, an apparatus for reducing crosstalk includes a liquid crystal polymer substrate having a bottom surface and a top surface, a broken ground plane having first and second sides separated by an opening, the broken ground plane coupled to the bottom surface of the liquid crystal polymer substrate, and first and second coplanar waveguides formed on the top surface of the liquid crystal polymer substrate, the first and second coplanar waveguides are spaced apart from one another, the first coplanar waveguide is formed over the first side of the broken ground plane and the second coplanar waveguide is formed over the second side of the broken ground plane. The apparatus further includes a first set of vias traveling through the substrate from the top surface of the substrate to the first side of the broken ground plane and positioned between the first and second coplanar waveguides for reducing crosstalk between the first and second coplanar waveguides, a second set of vias traveling through the substrate from the top surface of the substrate to the second side of the broken ground plane and positioned between the first and second coplanar waveguides for reducing crosstalk between the first and second coplanar waveguides, and a RFIC chip positioned on the liquid crystal polymer substrate and connected to the first and second coplanar waveguides.

### BRIEF DESCRIPTION OF THE DRAWINGS

The features, objects, and advantages of the invention will become more apparent from the detailed description set forth below when taken in conjunction with the drawings, wherein:

FIG. 1 is a schematic view of a prior art 3D integrated radar RF front-end system having antennas that are combined together using waveguides on a liquid crystal polymer (LCP) substrate;

FIG. 2 is a schematic top view showing four sources of crosstalk on a three-dimensional (3D) automotive radar RF front-end according to an embodiment of the invention;

FIG. 3 is a schematic top view of a portion of a 3D automotive radar RF front-end showing the interconnection scheme between a planar beam steering antenna array on an LCP substrate and a RFIC chip according to an embodiment of the invention;

FIG. 4 is a schematic top view of a portion of a 3D automotive radar RF front-end showing how the interconnection scheme between the planar beam steering antenna array on an LCP substrate, the RFIC chip and the 3D via transition combine to form the 3D automotive radar RF front-end according to an embodiment of the invention;

FIG. 5 includes schematic diagrams showing crosstalk between microstrip lines according to an embodiment of the invention;

FIG. 6 is a graph of a simulated forward coupling crosstalk between the two microstrip lines of FIG. 5 for different lateral separations C according to various embodiments of the invention;

FIG. 7 is a graph of a simulated backwards coupling crosstalk between the two microstrip lines of FIG. 5 for different lateral separations C according to various embodiments of the invention;

FIG. 8 is a schematic view showing a metallized via fence positioned between adjacent microstrip lines to reduce crosstalk according to an embodiment of the invention;

FIG. 9 is a top view showing a reduced coupled magnetic electric field due to the metallized via fence of FIG. 8 according to an embodiment of the invention;

FIG. 10 is a graph comparing the crosstalk (forward and backward) between two microstrip lines with the metallized via fence and without the metallized via fence according to an embodiment of the invention;

FIG. 11 is a graph showing the effects on backward crosstalk when the spacing S is reduced according to an embodiment of the invention;

FIG. 12 is a graph showing the effects on forward crosstalk when the spacing S is reduced according to an embodiment of the invention;

FIG. 13 is a schematic view showing two rows of metallized via fences positioned between microstrip lines to reduce crosstalk according to an embodiment of the invention;

FIG. 14 is a graph comparing the crosstalk (backward coupling) between the two microstrip lines of FIG. 13 with two rows of metallized via fences having different center-to-center spacings S between two adjacent vias according to an embodiment of the invention;

FIG. 15 is a graph comparing the crosstalk (forward coupling) between the two microstrip lines of FIG. 13 when no via fence is present, a single via fence is present, and a double via fence is present according to various embodiments of the invention;

FIG. 16 is a schematic view showing a double staggered metallized via fence positioned between adjacent microstrip lines to reduce crosstalk according to an embodiment of the invention;

FIG. 17 is a graph comparing the crosstalk (backward coupling) between the two microstrip lines of FIG. 16 when two staggered rows are implemented and two unstaggered rows (FIG. 13) are implemented according to various embodiments of the invention;

FIG. 18 is a graph showing the crosstalk (backward and forward coupling) between the two microstrip lines of FIG. 8 propagating signals at 76.5 GHz with a single metallized via fence positioned between the two microstrip lines according to an embodiment of the invention;

FIG. 19 is a cross-sectional view of adjacent CPW lines formed on a LCP substrate (ε=3.16, tan δ, thickness H) according to an embodiment of the invention;

FIG. 20 is a graph showing the crosstalk (backward coupling) between the two adjacent CPW lines for various values of ground plane separation D according to various embodiments of the invention;

FIG. 21 is a graph showing the crosstalk (backward coupling) between the two adjacent CPW lines for various values of ground plane width B according to various embodiment of the invention;

FIG. 22 is a cross-sectional view of adjacent CPW lines formed on the LCP substrate (ε=3.16, tan δ, thickness H) with the addition of two adjacent rows of metallized via fences positioned between the two adjacent CPW lines according to an embodiment of the invention; and

FIG. 23 is a graph showing the crosstalk (backward and forward coupling) between the two adjacent CPW lines when no via fence is present, a single via fence is present, and a double via fence is present according to various embodiment of the invention.

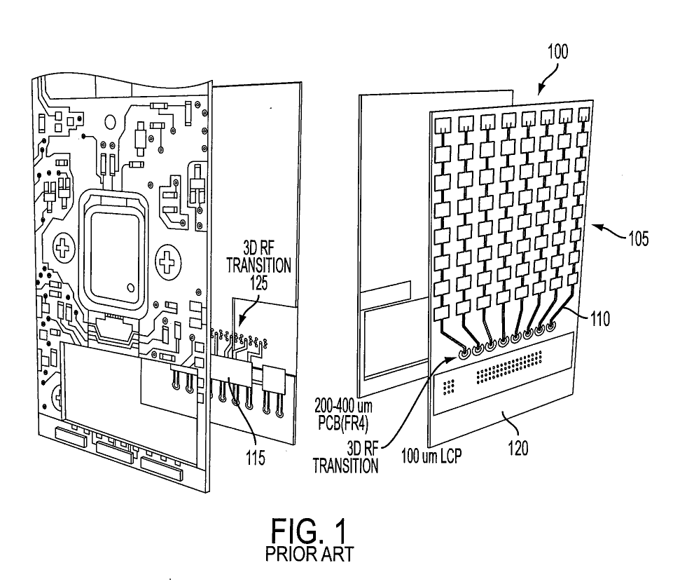

### DETAILED DESCRIPTION

Apparatus, systems and methods that implement the embodiments of the various features of the invention will now be described with reference to the drawings. The drawings and the associated descriptions are provided to illustrate some embodiments of the invention and not to limit the scope of the invention. Throughout the drawings, reference numbers are re-used to indicate correspondence between referenced elements.

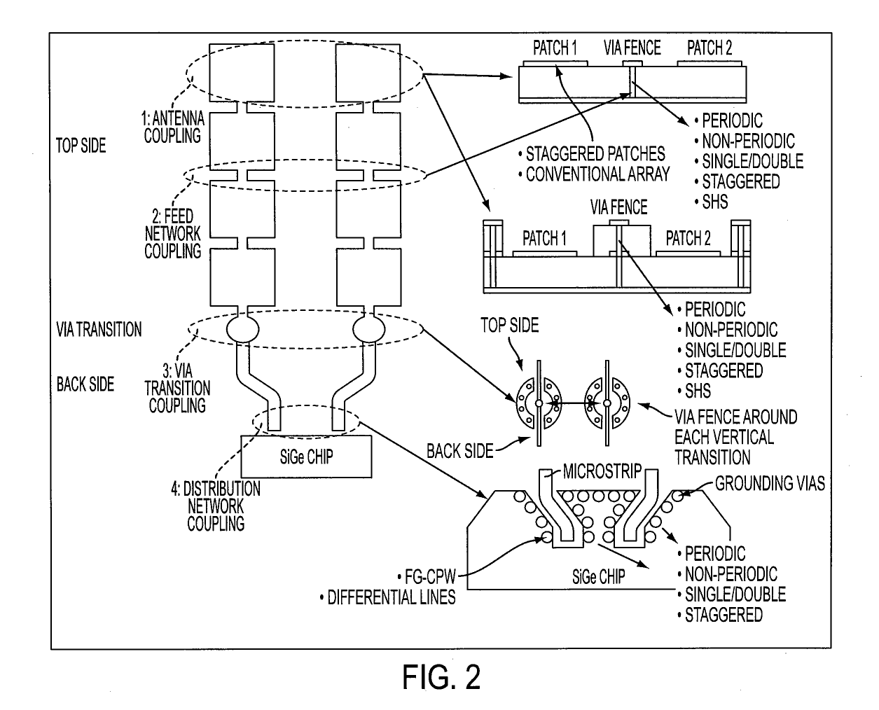

FIG. 2 is a schematic top view showing four sources of crosstalk on a three-dimensional (3D) automotive radar RF front-end 200 according to an embodiment of the invention. The four sources of crosstalk include (1) antenna coupling, (2) feed network coupling, (3) via transition coupling and (4) distributed network coupling. Since the 3D automotive radar RF front-end 200 generally operates as a phased array (as opposed to a switched-beam array), the first and second sources of crosstalk are less critical to the system performance. The third source of crosstalk is limited due to the use of a via fence around each 3D transition. However, the fourth source of crosstalk is important due to the close proximity of the transmission lines that are close to the location of the transmit/receive SiGe chip. Hence, a large portion of crosstalk reduction can be achieved by reducing the parasitic coupling between the microstrip and the CPW transmission lines.

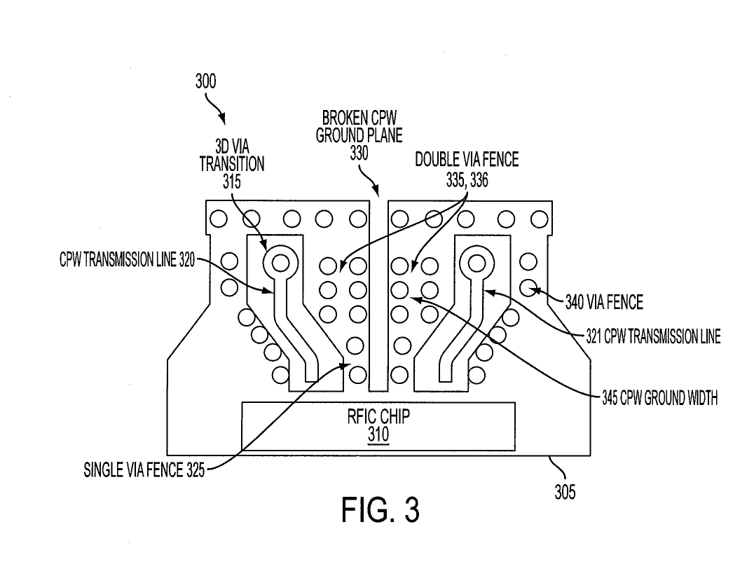

FIG. 3 is a schematic top view of a portion of a 3D automotive radar RF front-end 300 showing the interconnection scheme between a planar beam steering antenna array on an LCP substrate 305 and a RFIC chip 310 according to an embodiment of the invention. The portion of the 3D automotive radar RF front-end 300 may include a 3D via transition 315, a CPW transmission line 320, a single via fence 325, a broken CPW ground plane 330, two double via fences 335 and 336, a via fence 340, and a CPW ground width 345. The 3D automotive radar RF front-end 300 may be implemented using hardware, software, firmware, middleware, microcode, or any combination thereof. One or more elements can be rearranged and/or combined, and other radars can be used in place of the radar RF front-end 300 while still maintaining the spirit and scope of the invention. Elements may be added to the radar RF front-end 300 and removed from the radar RF front-end 300 while still maintaining the spirit and scope of the invention.

After the 3D via transition 315, the CPW transmission line 320 converges towards the RFIC chip 310. The 3D automotive radar RF front-end 300 utilizes one or more vias (e.g., the single via fence 325), made out of metallized vias, that are connected to a ground plane to isolate each CPW transmission line 320 from an adjacent or neighboring CPW transmission line 320. A center-to-center distance between adjacent vias is between about 0.5 mm to about 1.0 mm. The double via fences 335 and 336 (i.e., two vias side-by-side) allows for better isolation between CPW transmission lines 320 and 321. Each double via fence is positioned on one side of the CPW ground plane 330. As an example, each double via fences 335 and 336 has 3 sets of double vias. A double via means there are two vias positioned side-by-side. Each via may be filled with a metal material. As the CPW transmission lines 320 and 321 converge towards the RFIC chip 310, the single via fence 325 may be utilized due to size restrictions. The RFIC chip 310 is connected to the CPW transmission lines 320 and 321. A center-to-center lateral separation between the first and second microstrip lines is between about 500 μm to about 1500 μm.

The CPW ground plane 330 is broken to reduce crosstalk between the two CPW transmission lines 320 and 321. The reason for breaking or splitting the common CPW ground plane 330 is because surface waves that are created within the LCP substrate 305 can more easily propagate and parasitically couple to the adjacent CPW transmission lines 320 and 321. Also, the CPW ground plane 330 should have a width at least 3.5 times a width of the center conductor in order to achieve high isolation between the CPW transmission lines 320 and 321.

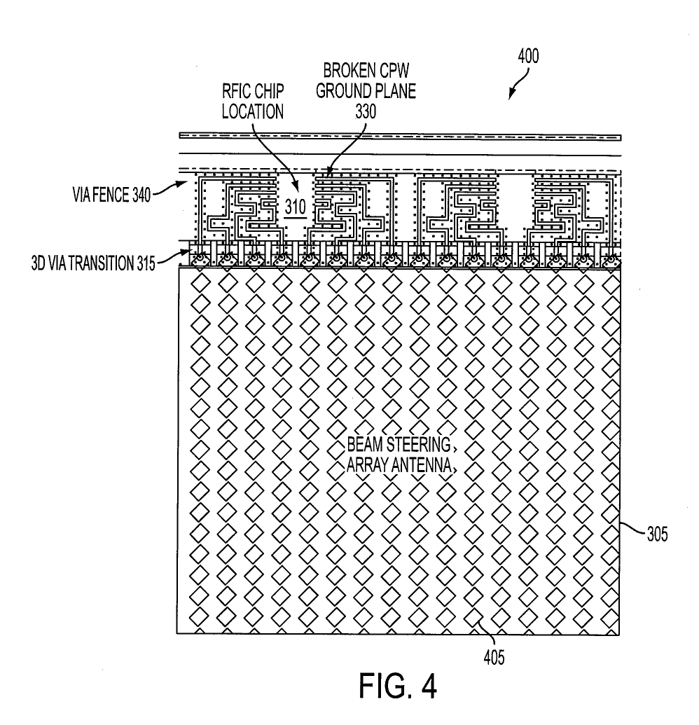

FIG. 4 is a schematic top view of a portion of a 3D automotive radar RF front-end 400 showing how the interconnection scheme between the planar beam steering antenna array 405 on an LCP substrate 305, the RFIC chip 310 and the 3D via transition 315 combine to form the 3D automotive radar RF front-end 400 according to an embodiment of the invention.

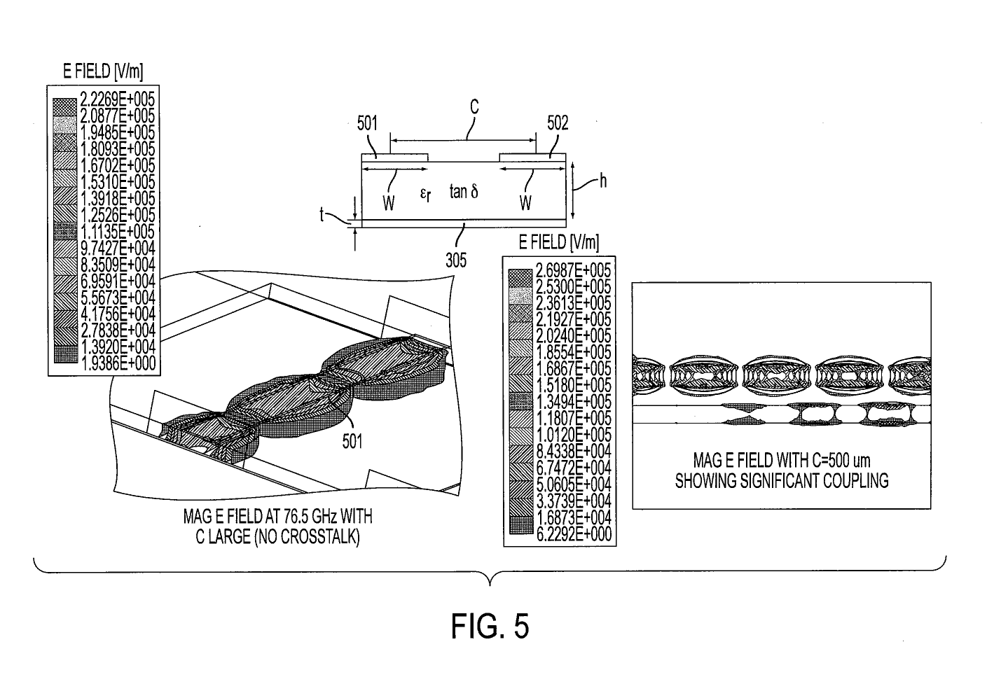

FIG. 5 includes schematic diagrams showing crosstalk between microstrip lines 501 and 502 according to an embodiment of the invention. Each microstrip line 501 and 502 has a width W and a metal thickness t. Each microstrip line 501 and 502 is printed on the LCP substrate 305 (e.g., where ε is about 3.16). The center-to-center lateral separation between the two adjacent microstrips 501 and 502 is C, which is about 500 μm. The lower left drawing shows the electrical field when no coupled microstrip line is present and the lower right drawing shows the electric field when the second microstrip line 502 is present at a distance C away from the first microstrip line 501.

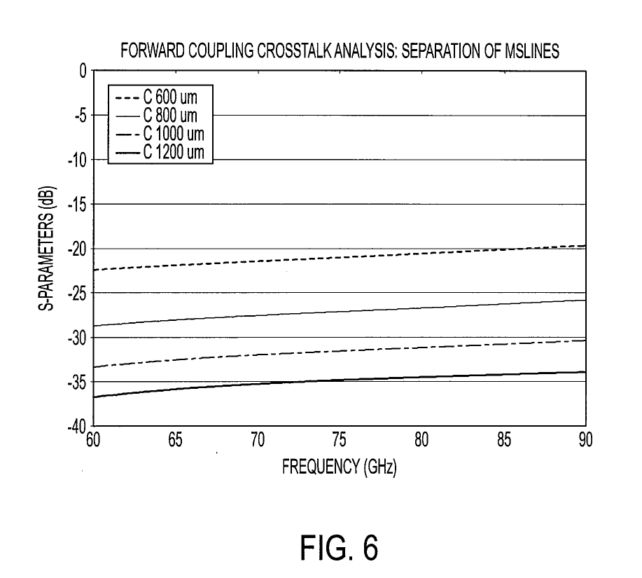

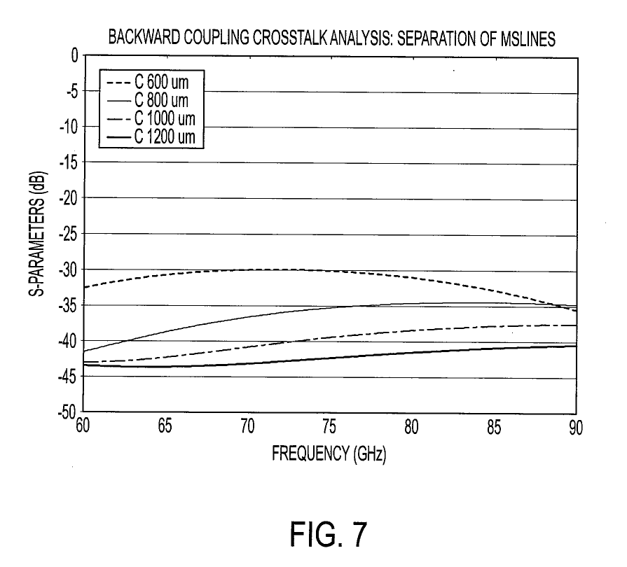

FIG. 6 is a graph of a simulated forward coupling crosstalk between the two microstrip lines 501 and 502 of FIG. 5 for different lateral separations C according to various embodiments of the invention. The forward coupling crosstalk shows a monotonic behavior versus frequency. FIG. 7 is a graph of a simulated backwards coupling crosstalk between the two microstrip lines 501 and 502 of FIG. 5 for different lateral separations C according to various embodiments of the invention. The backwards coupling crosstalk shows a standing wave pattern due to surface wave modes. For small distances, the forward coupling crosstalk is in the order of −20 dB and the backwards coupling crosstalk is in the order of −30 dB.

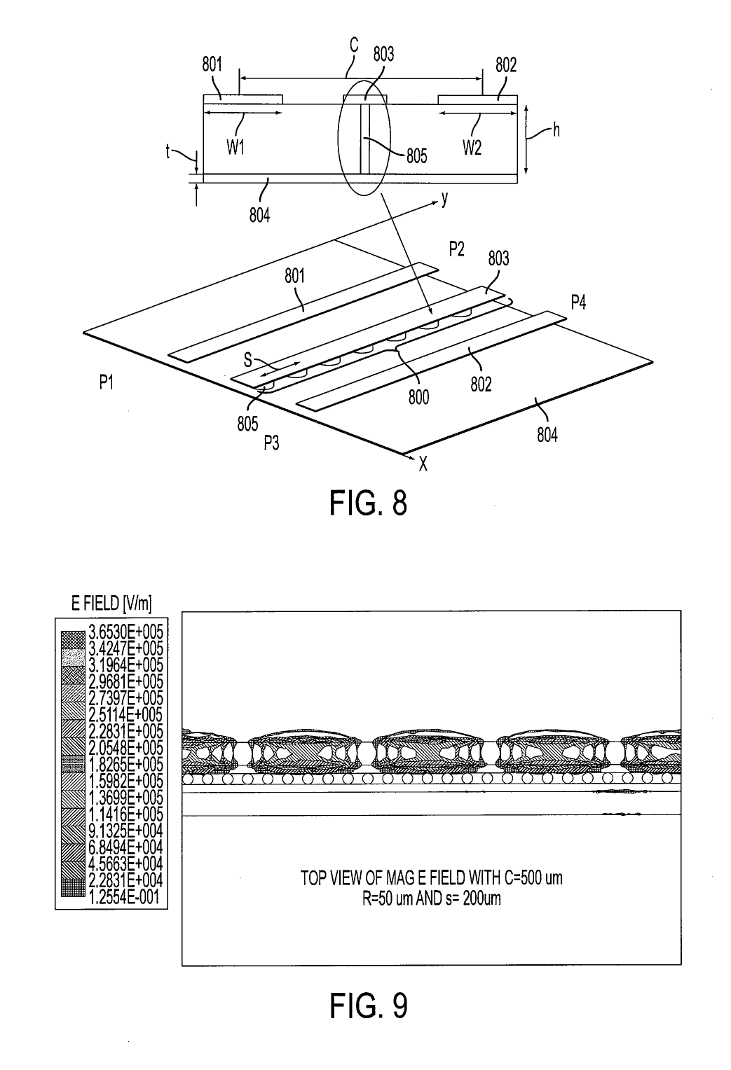

FIG. 8 is a schematic view showing a metallized via fence 800 positioned between adjacent microstrip lines 801 and 802 to reduce crosstalk according to an embodiment of the invention. The metallized via fence 800 includes a plurality of metallized vias 805, which are connected to a ground plane 804. The first microstrip line 801 has a width W1 and the second microstrip 802 line has a width W2. The center-to-center lateral spacing C (e.g., about 500 μm) is the lateral distance between adjacent microstrip lines 801 and 802. The plurality of metallized vias 805 have center-to-center spacing S of about 200 μm. Each metallized via 805 has a radius R of about 50 μm.

FIG. 9 is a top view showing a reduced coupled magnetic electric field due to the metallized via fence 800 of FIG. 8 according to an embodiment of the invention. That is, the coupled magnetic electric field from an aggressor signal is reduced due to the addition of the metallized via fence 800.

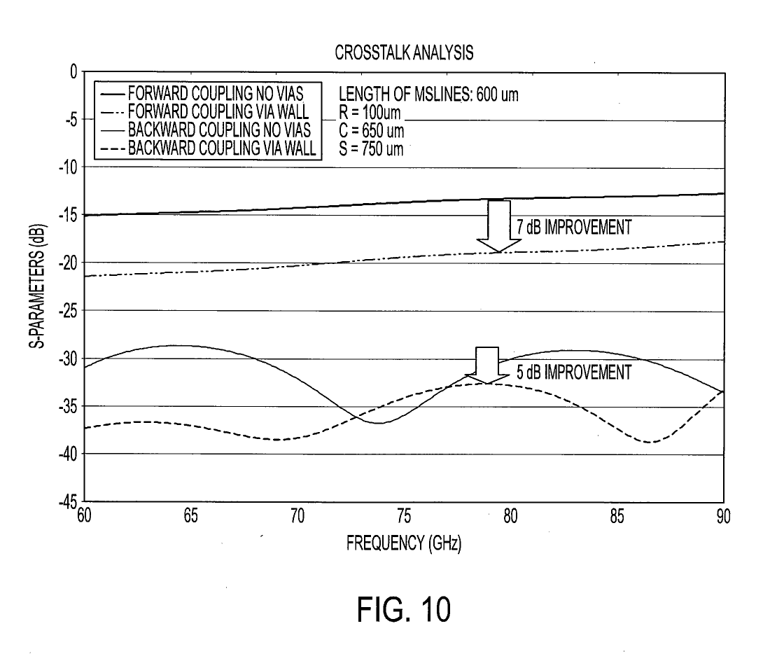

FIG. 10 is a graph comparing the crosstalk (forward and backward) between two microstrip lines 801 and 802 with the metallized via fence 800 and without the metallized via fence 800 according to an embodiment of the invention. In this example, C is about 650 μm, R is about 100 μm and S is about 750 μm. As an example, the metallized via fence 800 reduces crosstalk (forward coupling and backward coupling) by about 7 dB and 5 dB, respectively. The performance of the metallized via fence 800 in reducing crosstalk also depends on the center-to-center spacing S defining a distance between two adjacent metallized vias 805. A larger spacing S (i.e., the more sparse the metallized via fence 800) equates to a lesser improvement in the crosstalk. Also, a smaller spacing S equates to better isolation between the microstrip lines 801 and 802 to reduce crosstalk. The smaller spacing S also increases the production costs due to the larger number of metallized vias 805. Therefore, a design tradeoff exists between reducing crosstalk and increasing production costs.

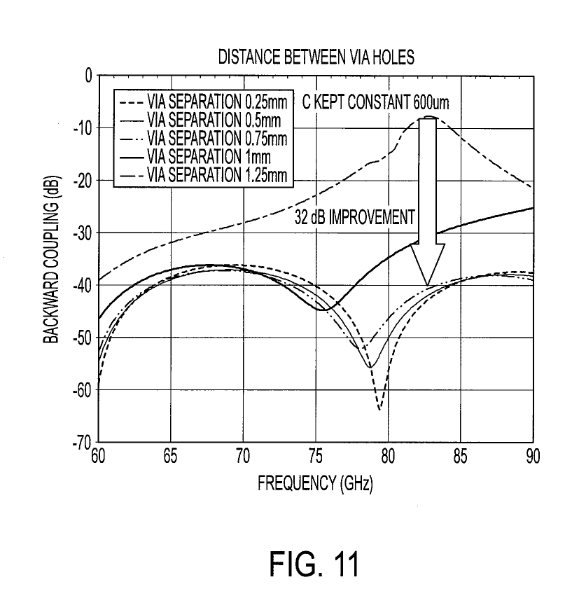

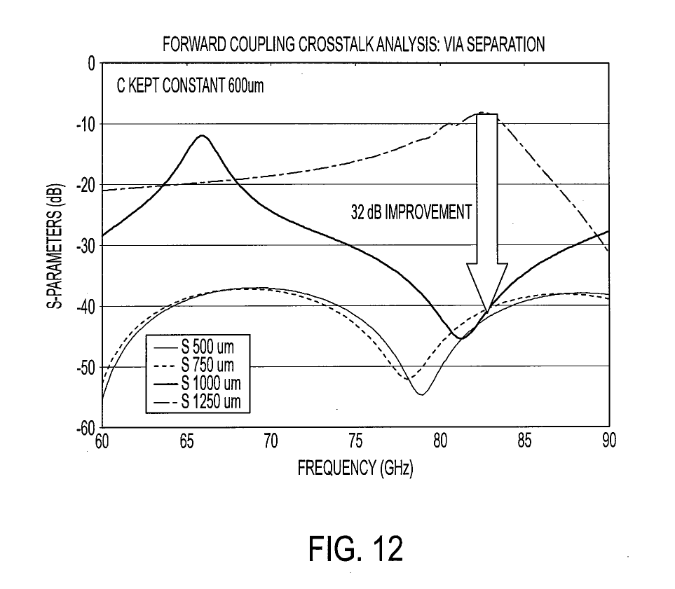

FIG. 11 is a graph showing the effects on backward crosstalk when the spacing S is reduced according to an embodiment of the invention. FIG. 12 is a graph showing the effects on forward crosstalk when the spacing S is reduced according to an embodiment of the invention. Referring to FIGS. 11 and 12, a 32 dB improvement in backward and forward coupling or crosstalk is depicted when the center-to-center spacing S is reduced from 1.25 mm to 0.75 mm. Furthermore, reducing the spacing below 0.75 mm does not yield a significant reduction in crosstalk and therefore a center-to-center spacing of about 0.75 mm is an optimal value for reducing crosstalk when the signals are being transmitted at around 77 GHz.

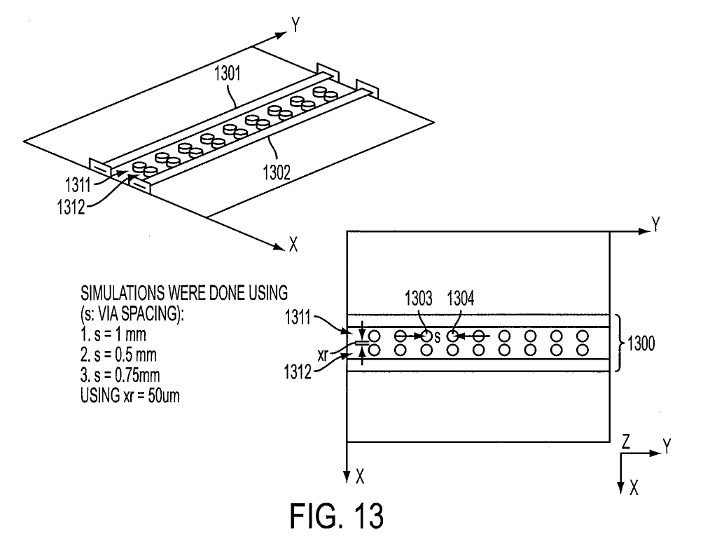

FIG. 13 is a schematic view showing two rows of metallized via fences 1300 positioned between microstrip lines 1301 and 1302 to reduce crosstalk according to an embodiment of the invention. The first row 1311 and the second row 1312 are positioned adjacent to one another. Each row may have a plurality of metallized vias 1303. The second row 1312 of metallized vias 1303 improves the performance (i.e., reduces crosstalk) by about 15 dB. The distance xr between adjacent rows is about 50 μm. The center-to-center spacing S between adjacent vias can be 1 mm, 0.5 mm or 0.75 mm.

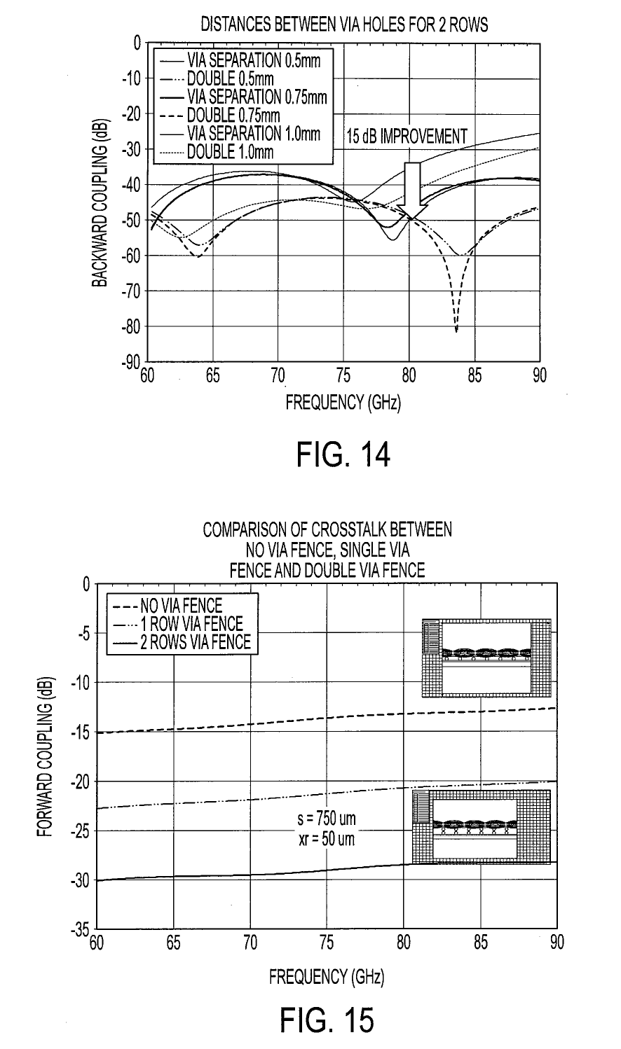

FIG. 14 is a graph comparing the crosstalk (backward coupling) between the two microstrip lines 1301 and 1302 of FIG. 13 with two rows 1311 and 1312 of metallized via fences 1300 having different center-to-center spacings S between two adjacent vias 1303 and 1304 according to an embodiment of the invention.

FIG. 15 is a graph comparing the crosstalk (forward coupling) between the two microstrip lines 1301 and 1302 of FIG. 13 when no via fence is present, a single via fence is present, and a double via fence 1300 is present according to various embodiments of the invention.

FIG. 16 is a schematic view showing a double staggered metallized via fence 1600 positioned between adjacent microstrip lines 1601 and 1602 to reduce crosstalk according to an embodiment of the invention. The double metallized via fence 1600 includes a first row 1603 and a second row 1604 positioned adjacent to the first row 1603. The first row 1603 and the second row 1604 have staggered metallized vias 1605. That is, each row has a plurality of staggered metallized vias 1605, which are each connected to a ground plane 1606. The first row 1603 has center-to-center spacing S and the second row 1604 has center-to-center spacing S′ where S/S′ is about equal to 2. The center-to-center spacing S may be equal to 1 mm, 0.5 mm or 0.75 mm. The distance xr between the two rows may be equal to about 50 μm.

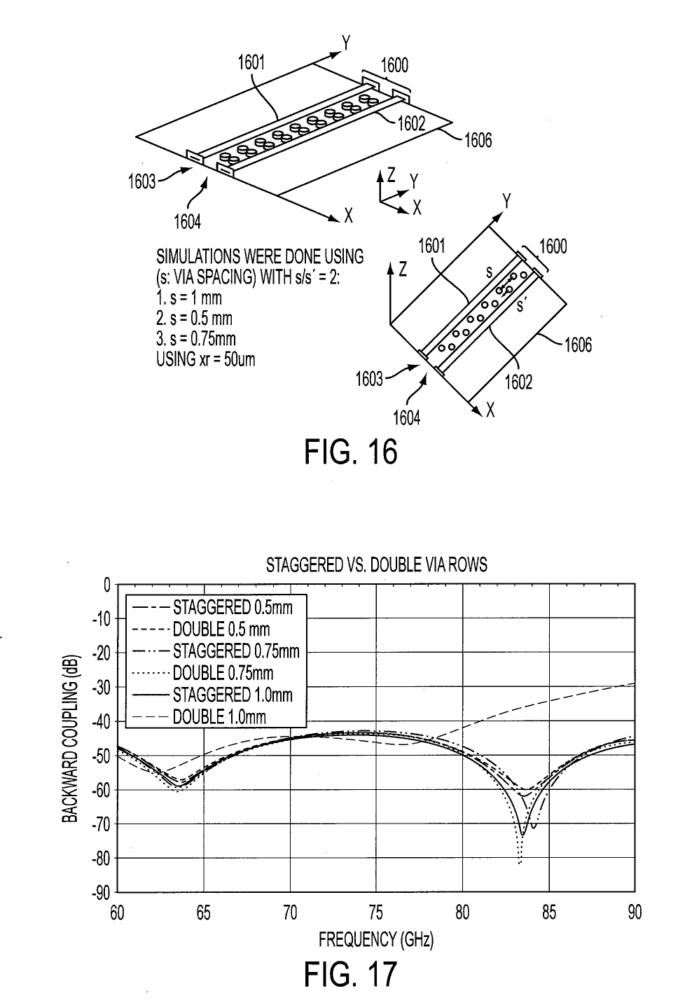

FIG. 17 is a graph comparing the crosstalk (backward coupling) between the two microstrip lines 1601 and 1602 of FIG. 16 when two staggered rows 1600 are implemented and two unstaggered rows 1300 (FIG. 13) are implemented according to various embodiments of the invention.

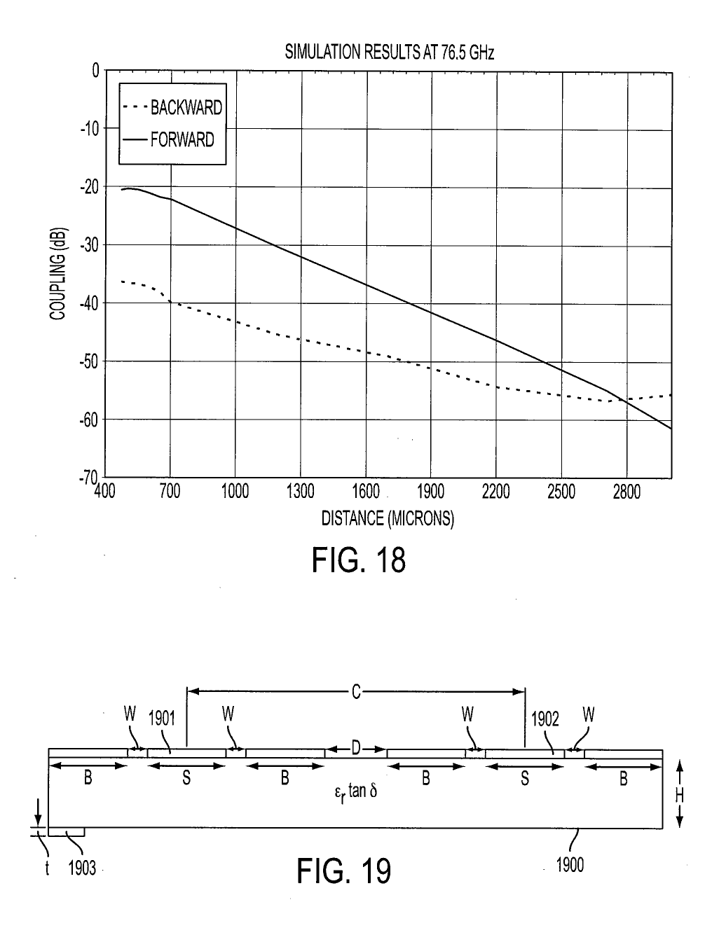

FIG. 18 is a graph showing the crosstalk (backward and forward coupling) between the two microstrip lines 801 and 802 of FIG. 8 propagating signals at 76.5 GHz with a single metallized via fence 800 positioned between the two microstrip lines 801 and 802 according to an embodiment of the invention. The center-to-center spacing s between adjacent vias 805 is about 0.75 mm. The lateral separation C (Distance) between adjacent microstrip lines 801 and 802 varies as shown in the graph. An isolation of more than 30 dB can be achieved when the lateral separation C is 1.2 mm or greater.

FIG. 19 is a cross-sectional view of adjacent CPW lines 1901 and 1902 formed on a LCP substrate 1900 (ε=3.16, tan δ, thickness H) according to an embodiment of the invention. The two adjacent CPW lines 1901 and 1902 with ground plane width B, slot W, signal S and distance D are printed on the LCP substrate 1900. The thickness of a copper trace 1903 is t.

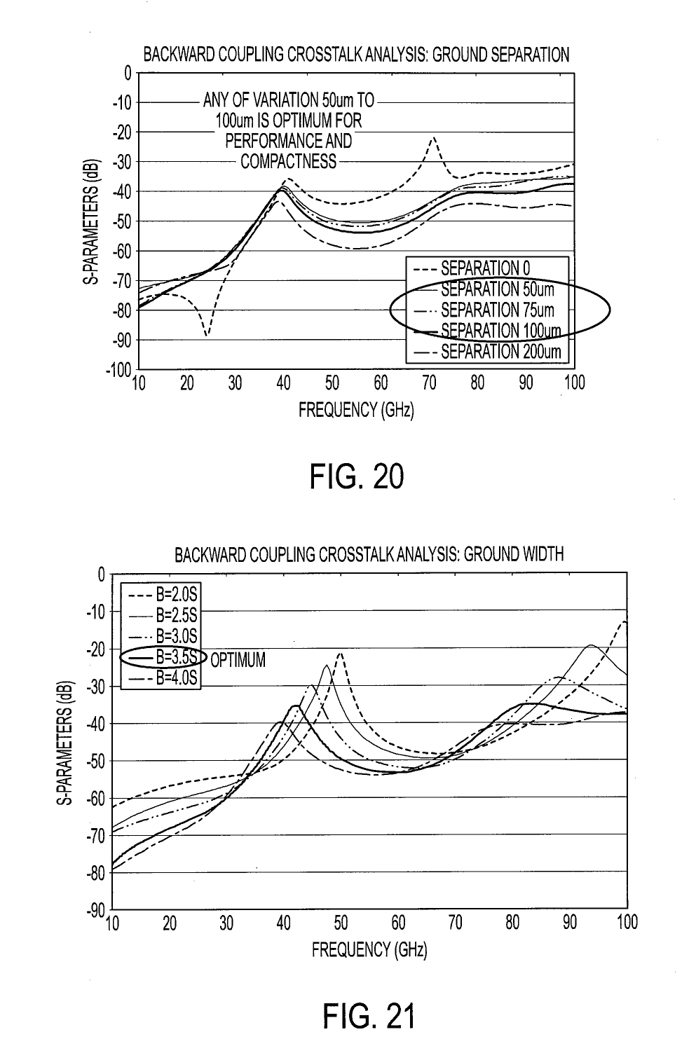

FIG. 20 is a graph showing the crosstalk (backward coupling) between the two adjacent CPW lines 1901 and 1902 for various values of ground plane separation D according to various embodiments of the invention. When D is 0, the two adjacent CPW lines 1901 and 1902 have a common ground. This provides an increased value for crosstalk due to surface wave modes that propagate under the common ground plane. A 75 μm to 100 μm separation between the CPW ground planes allows for the optimal reduction in crosstalk.

FIG. 21 is a graph showing the crosstalk (backward coupling) between the two adjacent CPW lines 1901 and 1902 for various values of ground plane width B according to various embodiment of the invention. The optimal ground plane width B is achieved when B=3.5S.

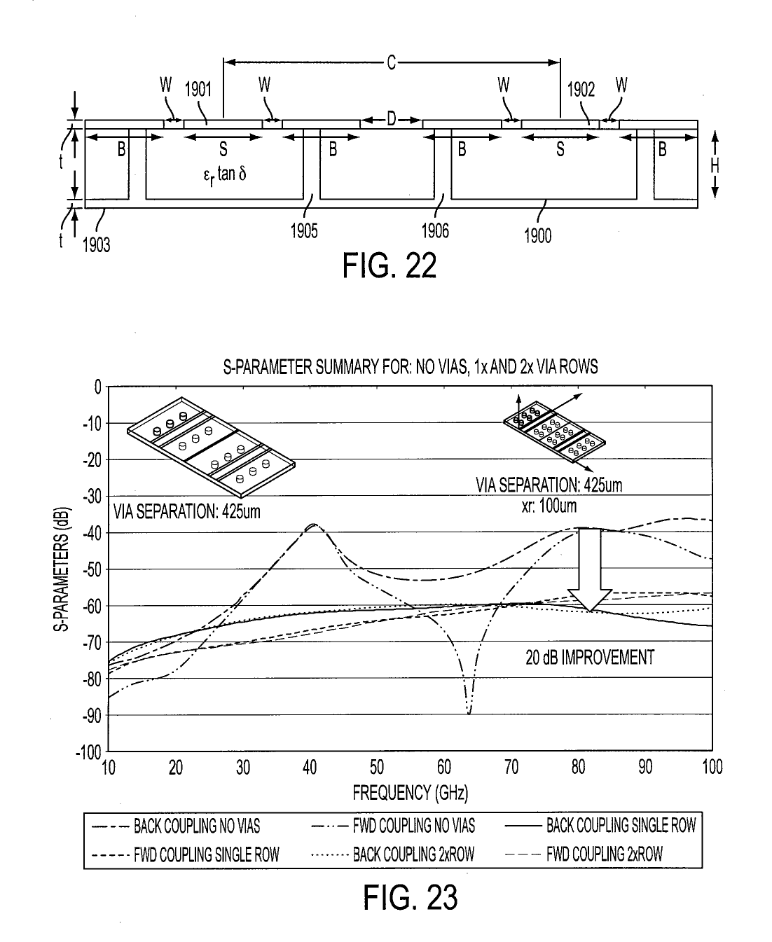

FIG. 22 is a cross-sectional view of adjacent CPW lines 1901 and 1902 formed on the LCP substrate 1900 (ε=3.16, tan δ, thickness H) with the addition of two adjacent rows of metallized via fences 1905 and 1906 positioned between the two adjacent CPW lines 1901 and 1902 according to an embodiment of the invention. The two adjacent CPW lines 1901 and 1902 with ground plane width B, slot W, signal S and distance D are printed on the LCP substrate 1900. The thickness of a copper trace 1903 is t. The two rows of metallized via fences 1905 and 1906 positioned between the two adjacent CPW lines 1901 and 1902 improves the isolation by about 20 dB. The improved isolation is important at locations close to the feed of the T/R module.

FIG. 23 is a graph showing the crosstalk (backward and forward coupling) between the two adjacent CPW lines 1901 and 1902 when no via fence is present, a single via fence is present, and a double via fence is present according to various embodiment of the invention. The center-to-center via spacing S is about 425 μm.

Those of ordinary skill would appreciate that the various illustrative logical blocks, modules, and algorithm steps described in connection with the examples disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the disclosed apparatus and methods.

The previous description of the disclosed examples is provided to enable any person of ordinary skill in the art to make or use the disclosed methods and apparatus. Various modifications to these examples will be readily apparent to those skilled in the art, and the principles defined herein may be applied to other examples without departing from the spirit or scope of the disclosed method and apparatus. The described embodiments are to be considered in all respects only as illustrative and not restrictive and the scope of the invention is, therefore, indicated by the appended claims rather than by the foregoing description. All changes which come within the meaning and range of equivalency of the claims are to be embraced within their scope.

What is claimed is:

1. An apparatus for reducing crosstalk comprising:
a substrate having a bottom surface and a top surface defining a horizontal plane;
a ground plane coupled to the bottom surface of the substrate;
first and second microstrip lines formed on the top surface of the substrate, the first and second microstrip lines formed on the top surface of the substrate and spaced apart from one another; and
a first plurality of vias traveling through the substrate from the top surface of the substrate to the ground plane and positioned between the first and second microstrip lines for reducing crosstalk between the first and second microstrip lines.

2. The apparatus of claim 1 wherein the ground plane is broken between the first and second microstrip lines to reduce crosstalk between the first and second microstrip lines.

3. The apparatus of claim 1 wherein the first plurality of vias include two vias positioned side-by-side to form a double via fence.

4. The apparatus of claim 1 wherein the substrate is a liquid crystal polymer substrate.

5. The apparatus of claim 1 wherein the first and second microstrip lines are coplanar waveguides.

6. The apparatus of claim 1 wherein a center-to-center distance between adjacent vias is between about 0.5 mm to about 1.0 mm.

7. The apparatus of claim 1 wherein a center-to-center lateral separation between the first and second microstrip lines is between about 500 μm to about 1500 μm.

8. The apparatus of claim 1 wherein each of the first plurality of vias is filled with a metal material.

9. The apparatus of claim 1 further comprising a second plurality of vias traveling through the substrate from the top surface of the substrate to the ground plane and positioned between the first and second microstrip lines for reducing crosstalk between the first and second microstrip lines.

10. The apparatus of claim 9 wherein each of the second plurality of vias is filled with a metal material.

11. The apparatus of claim 1 further comprising a RFIC chip positioned on the substrate and connected to the first and second microstrip lines.

12. An apparatus for reducing crosstalk comprising:
a liquid crystal polymer substrate having a bottom surface and a top surface;
a broken ground plane having first and second sides separated by an opening, the broken ground plane coupled to the bottom surface of the liquid crystal polymer substrate;
first and second coplanar waveguides formed on the top surface of the liquid crystal polymer substrate, the first and second coplanar waveguides spaced apart from one another, the first coplanar waveguide is formed over the first side of the broken ground plane and the second coplanar waveguide is formed over the second side of the broken ground plane;
a first set of vias traveling through the substrate from the top surface of the substrate to the first side of the broken ground plane and positioned between the first and second coplanar waveguides for reducing crosstalk between the first and second coplanar waveguides;
a second set of vias traveling through the substrate from the top surface of the substrate to the second side of the broken ground plane and positioned between the first and second coplanar waveguides for reducing crosstalk between the first and second coplanar waveguides; and
a RFIC chip positioned on the liquid crystal polymer substrate and connected to the first and second coplanar waveguides.

13. The apparatus of claim 12 wherein the first set of vias include two vias positioned side-by-side to form a double via fence.

14. The apparatus of claim 12 wherein the second set of vias include two vias positioned side-by-side to form a double via fence.

15. The apparatus of claim 12 wherein each of the first set of vias is filled with a metal material.

16. The apparatus of claim 12 wherein each of the second set of vias is filled with a metal material.

17. The apparatus of claim 12 wherein the first set of vias include two parallel rows of vias positioned side-by-side to form a double via fence.

18. The apparatus of claim 12 wherein the second set of vias include two parallel rows of vias positioned side-by-side to form a double via fence.

19. The apparatus of claim 12 wherein the first set of vias include a single row of vias positioned to form a single via fence.

20. The apparatus of claim 12 wherein the second set of vias include a single row of vias positioned to form a single via fence.
